(19) United States
(12) Patent Application Publication
(10) Pub. No.: US 2018/0257119 A1
(43) Pub. Date: Sep. 13, 2018

(54) CLEANING INSIDE AND ADJACENT SERVICE CONNECTIONS IN PREPARATION FOR PIPE LINING METHOD

(71) Applicant: ENVIROLOGICS ENGINEERING Inc., Ontario (CA)

(72) Inventors: Kevin LILLIE, Ontario (CA); Brian THOROGOOD, Ontario (CA)

(21) Appl. No.: 15/760,157

(22) PCT Filed: Mar. 2, 2016
(86) PCT No.: PCT/CA16/50218

§ 371 Date: Mar. 14, 2018

(51) Int. Cl. B08B 9/057; B08B 9/035; B24C 3/32

(52) U.S. Cl. CPC B08B 9/057; B08B 9/035; B08B 2209/022; B08B 2209/053; B24C 3/327

(57) ABSTRACT

The methods for cleaning pipes with service connections includes vacuuming therethrough abrasive projectiles first in one direction, and thereafter, in an opposing direction, with additional cleaning achieved by opening of service connection valves during vacuuming. By opening service connection valves during vacuuming, debris and moisture are removed from within the service connections. Vacuuming direction reversal removes shadow deposit areas.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

### 1. Field of the Invention

The present invention relates to cleaning pipe service connections, and more specifically cleaning inside and adjacent pipe service connections in preparation for pipe lining.

### 2. Description of Related Art Including Information Disclosed Under 37 CFR 1.97 and 37 CFR 1.98

Transport pipes (especially liquid transport pipes) are known to become infested with many forms of build up, including tubercles in a case of municipal water pipes.

A tubercle is, generally, a bumpy, rocky, and rigid protuberance, forming a wartlike lesion in pipes. Tubercles arise from natural atherosclerosis and mineral deposition, pollution, residual matter, and living organisms. Tubercules and other such encrustation are forms of adhered pipe wall deposits.

All adhered pipe wall deposits must be removed from a pipe prior to attempting a rehabilitative lining or coating.

Cleaning pipes (of all adhered deposits and loose debris) having service connections is even more difficult, because service connections often trap loose debris and moisture therein. Loose debris means pieces of pipe (formerly adhered) wall deposits that have been liberated from the pipe wall during the cleaning process. Current cleaning solutions typically leave loose debris and moisture resident within these service connections.

One option in dealing with deposit removal is to replace infected (ie sclerotic) pipes, but this is frequently unnecessary, time consuming, impractical in urban areas and established neighbourhoods with paved roads, green boulevards and mature trees, expensive, increase carbon footprint, and results in an additional problem of waste pipe disposal.

Another option is to flush liquids and chemicals through the pipe, to try to dissolve and wash away adhered deposits and other buildup. Liquid/chemical flushing is inefficient, requires large volumes of liquid that is either toxic or becomes toxic following pipe cleaning, and increases the time a pipe is maintained in a wet condition (pipes cannot be lined subsequent to cleaning if they are wet—the pipes must be dried thoroughly before applying a liner). Because pipes remain wet (and so await lining) for a longer time, they are correspondingly out of service for a longer time. Yet another issue with chemical flushing is human exposure, and environmental disposal concerns (especially when treating drinking water pipes).

Still another option is to focus a high pressure jet (fluid) at deposits for removal from the pipe wall. This requires a large volume of liquid for cleaning and flushing, and requires the pipe to be dried prior to lining. The high pressure fluid can exert great force on the pipe wall and joints, causing damage.

Still yet another option is to use scraping means that exert great mechanical force on the pipe wall to remove adhered deposits. These methods require high volumes of liquid to flush out the debris during cleaning, may require containment and proper disposal of liquid waste, and leaves the pipe wet. Scraping means can exert forces that damage the pipe wall and joints, as well as protruding service connections.

Yet another option is to accelerate (using a blower/gas compressor (ie positive pressure)) abrasive projectiles (like rocks of progressive calibre) through sclerotic pipes. A pipe is pressurized with a continuous unidirectional gas stream (typically in the 15-30 pounds per square inch (PSI) range), and abrasive projectiles are fed into the stream. The streaming projectiles strike and break away protruding adhered deposit portions, and discharge out of the pipe along with loose debris.

When cleaning pipes having service connections, by way of any scraping, jetting, flushing (liquid), or (positive pressure) gas streaming methods, the service connections commonly accumulate and trap loose debris and moisture therein. When trying to subsequently line pipes, service connections often then spill that debris and moisture into the pipes, and that moisture and debris prevents proper lining of the pipe. Pipe lining is a necessary end step for pipe rehabilitation and restoration.

Scraping, jetting, positive pressure flushing (and airstreams) tend to push debris and moisture further up service connection lines. Also, debris left in a service connection line can become covered over during the lining process to the point of creating a flow restriction or water tight seal if the debris is not removed prior to lining. If this occurs, remediation will be required prior to returning the pipe to service.

Improperly cleaned areas and shadow deposit encrusted areas prevent a smooth, continuous, well-bonded lining application to the pipe wall in these crucial areas.

Improperly cleaned areas inside service connections also result in debris being trapped downstream when pipes are recharged and re-introduced into service.

Presently, there is no known way to easily avoid or remove that debris and moisture from the service connection (during the actual cleaning phase), and so lining post cleaning, in the vicinity of service connections, is often poor even though the pipe has been otherwise thoroughly cleaned.

A second and additional problem is that in scraping, jetting, flushing and (positive pressure) gas stream cleaning solutions, service connections often produce shadow (uncleaned) deposit encrustation areas downstream from service connections. These uncleaned areas also interfere with pipe-lining.

Proper pipe-lining is necessary in order to prevent leakage, and to extend the lifespan of any cleaned or rehabilitated pipe.

### BRIEF SUMMARY OF THE INVENTION

In one embodiment the present invention is a method of cleaning pipe comprising vacuuming projectiles into one pipe end through to the other pipe end, and then reversing cleaning direction by switching position of the vacuum source and the projectile source.

In another it is a method of removing debris and moisture from pipe service connections by opening service connection valves during pipe vacuuming.

### BRIEF DESCRIPTION OF THE SEVERAL VIEWS OF THE DRAWINGS

FIG. 1 is a perspective view of a pipe with service connections having a vacuum source at a first end, and a projectile source at an opposing second pipe end.

FIG. 2 is a cut away view of a pipe inside showing the pipe vacuum cleaned in one direction only and leaving a shadow (proximal to the vacuum source) adjacent a pipe service connection.

FIG. 3 is a perspective view of a pipe with service connections having the projectile source at the first end, and the vacuum source at the second pipe end.

FIG. 4A is an enlarged cut-away view of the circled portion in FIG. 1, showing the pipe vacuum cleaned in a direction opposing that shown in FIG. 2 resulting in shadow removal, with the service connection valve closed.

FIG. 4B is a cut away view of the circled portion in FIG. 1 showing the pipe vacuum cleaned in a direction opposing that shown in FIG. 2 with the service connection valve opened, resulting in debris and moisture release from inside the service connection.

### DETAILED DESCRIPTION OF THE INVENTION

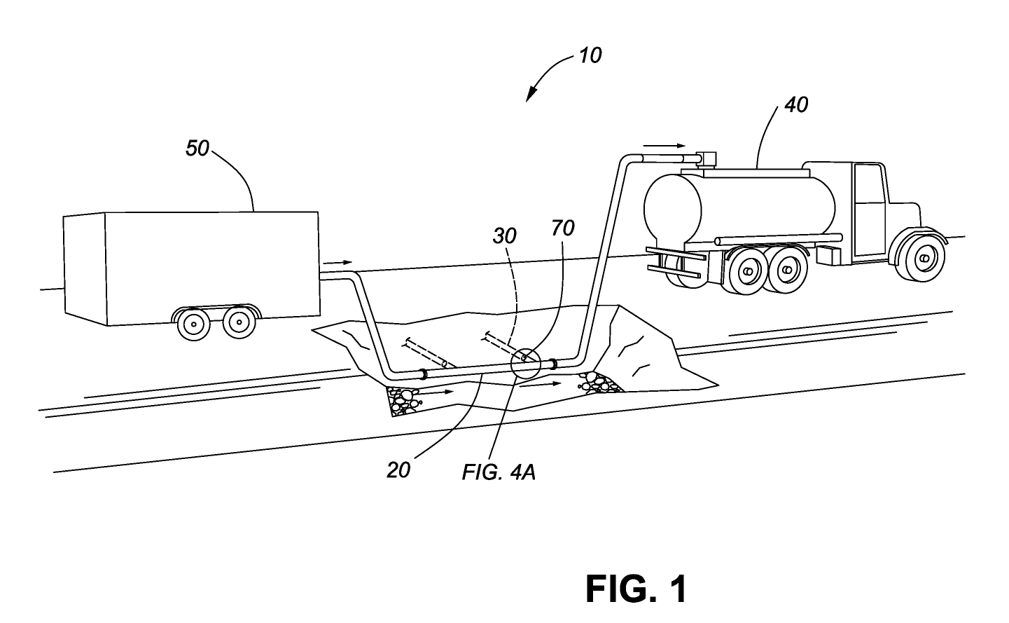

FIG. 1 shows generally 10 a perspective view of an in situ pipe 20 with service connections 30 having a vacuum source 40 at a first end, and a projectile source (dispensary) 50 at an opposing second pipe end. The vacuum source 40 is usually inside a large truck body or trailer, also having a container for catching and receiving abrasives and debris 80.

The projectile source 50 is typically housed in a truck or trailer, and includes a large hopper and feeder (not shown). Inside the trailer, projectiles (depending on the cleaning job, from hundreds to thousands of pounds worth) are dumped into the hopper and fed into the pipe 20 from one end to another.

The pipe 20 to be cleaned is accessed in situ (rather than cut away and excavated).

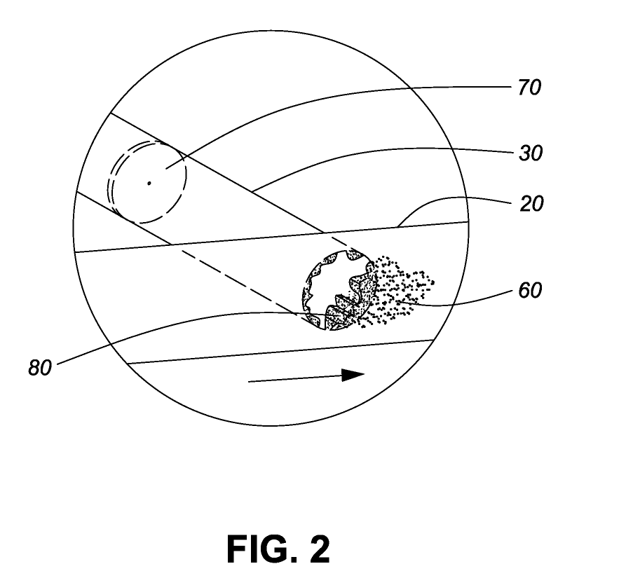

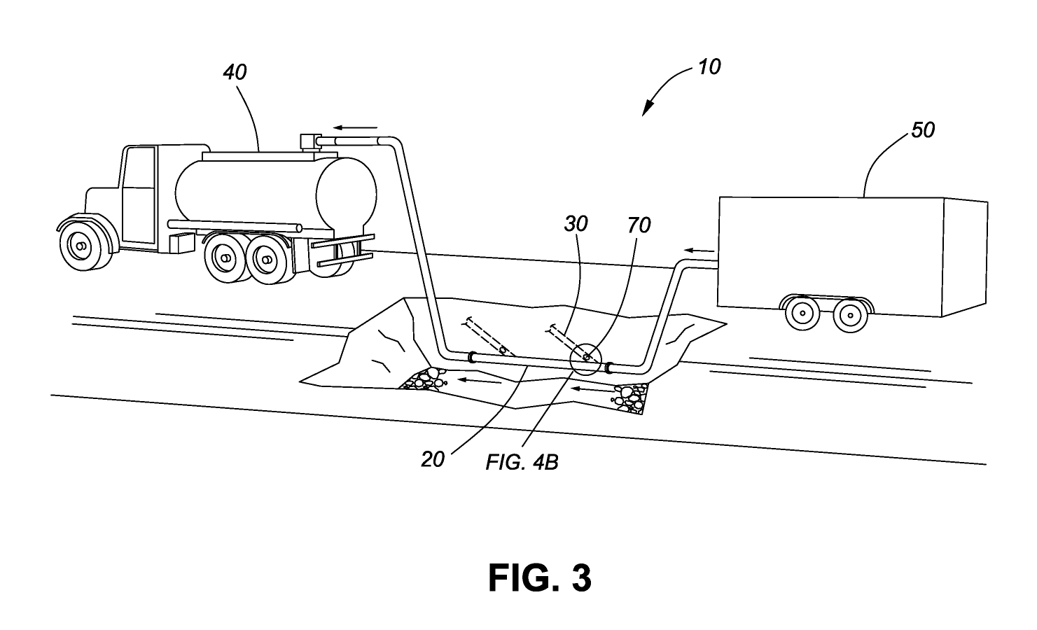

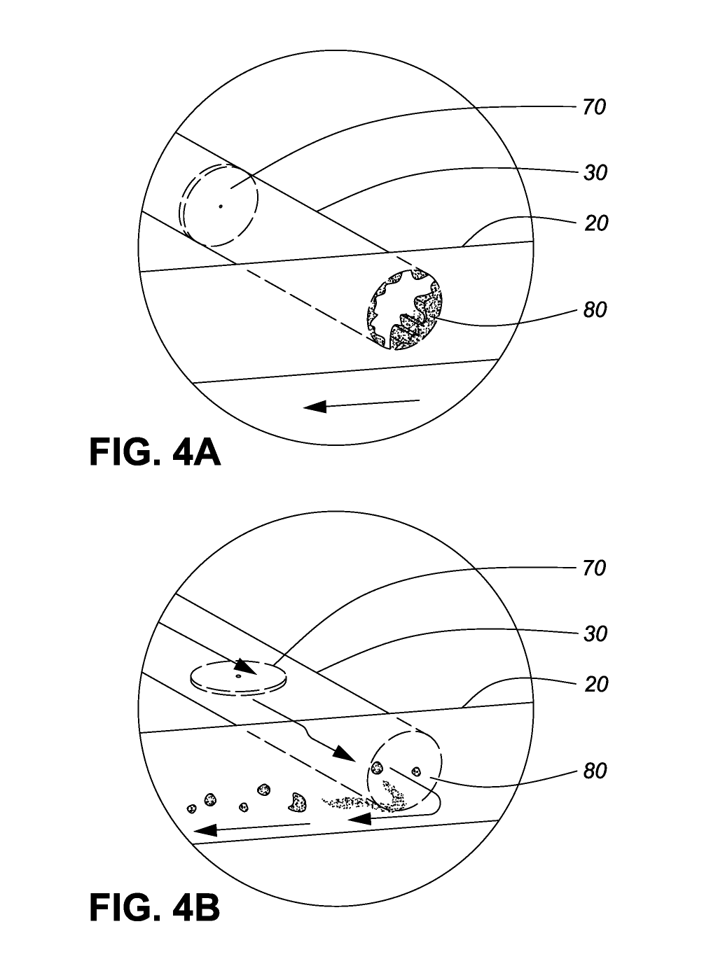

In one embodiment, a method for cleaning an in situ pipe 20 is disclosed as follows. FIG. 1 shows the pipe 20 having two opposed open ends and defining an interior passage therethrough from pipe 20 end to end. The pipe 20 has a valve-controlled 70 service connection 30 connected to the pipe 20 between the pipe ends. The service connection 30 is in communication with the pipe 20 interior passage. The valve 70 is controllable/moveable between an open (FIG. 4B) and a closed (FIG. 2) position.

It is typical to find service connection 30 valve 70 in a closed (FIG. 2) position on commencing this method. The vacuum 40 is attached to the first pipe 20 end (FIG. 1).

Vacuuming commences to create a unidirectional simultaneous full length gas stream in the pipe 20, running from the second end to the first end. Once vacuuming has started, the service connection valve 70 is opened (FIG. 4A).

By opening the valve 70 in the presence of the simultaneous full length unidirectional gas stream, debris 80 is freed and removed from inside the service connection 30. The opening of the service valve 70 in the presence of the vacuum results in a clean connection 30, with no interference during lining (not shown).

For stubbornly clogged service connections, liquid or abrasives can be injected into the service connection gas stream for enhanced force in debris 80 purging.

For as long as the valve 70 stays closed (during the cleaning process), the deposits 80 otherwise remain in the service connection 30.

In another embodiment, another method for cleaning an in situ pipe 20 having a service connection 30 is disclosed. This method is commenced by vacuuming abrasive particulate from the second pipe end through to the first pipe end in a unidirectional simultaneous full length gas stream from the second pipe end to the first pipe end.

When desired, the vacuuming from the second pipe 20 end through to the first pipe 20 end is ceased.

Thereafter, abrasive particulate is vacuumed from the first pipe 20 end through to the second pipe 20 end to create a unidirectional simultaneous full length gas stream from the first pipe 20 end to the second pipe 20 end.

That is, the projectile source (dispensary) 50 and the vacuum 40 switch locations with each other. By this method of cleaning, shadow deposit 60 encrustation areas adjacent service connections 30 are eliminated, thus allowing for clean, proper, and effective lining.

An additional benefit of gas stream cleaning from both ends (both directions) is the elimination of deposit shadows behind other protruding features such as offset joints, through elbows, and T-intersections, thereby allowing effective lining in these locations.

Cleaning from both ends has an added benefit of reducing the amount of projectiles required to clean the pipe 20. Projectiles in the gas stream reach their highest speed and cleaning effectiveness at the end of the pipe closest to the vacuum. Switching ends evens out this impact and so unexpectedly yields increased abrasive usage efficiency.

By practising both of the embodiments claimed herein in concert and sequence, a unifying problem (or theme) is addressed, namely how to prepare a pipe 20 for final coating/lining post projectile-based adhered deposit removal and cleaning. Cleaning adhered deposits by abrasive projectiles and other cleaning methods described earlier, always results in debris 80, abrasives (if used) and moisture being collected in service lines and encrusted deposits 60 remaining adjacent to service connections 30.

The embodiments herein result in a removal of the service connection 30 debris 80 and the encrusted deposits 60 downstream of service connections 30, revealing a smooth and clean pipe 20 surface (ie properly prepared for lining/coating). Where the pipe 20 surface is not smooth and clean (ie free of debris 80 and deposits 60), the lining/coating will fail to hold and bond properly, and the pipe 20 will thereafter be subjected to repeat, accelerated, and aggressive degradation.

1-10 (canceled)

11. A method for cleaning an in situ pipe having two opposed open ends and defining an interior passage therethrough from pipe end to end, the method comprising:
i) vacuuming abrasive particulate from the second pipe end through to the first pipe end in a unidirectional simultaneous full length gas stream from the second pipe end to the first pipe end;
ii) ceasing vacuuming from the second pipe end through to the first pipe end; and
iii) thereafter vacuuming the abrasive particulate from the first pipe end through to the second pipe end to create a unidirectional simultaneous full length gas stream from the first pipe end to the second pipe end,
wherein the in situ pipe further has at least one valve-controlled service connection connected to the pipe between the pipe ends, the at least one valve-controlled service connection being in fluid communication with the pipe interior passage, the at least one valve-controlled service connection being controllable between an open and a closed position, and
wherein the abrasive particulate is vacuumed from the first pipe end through to the second pipe end to clean shadow deposit encrustation areas adjacent the at least one valve-controlled service connection.

12. (canceled)

13. A method for cleaning an in situ pipe having a) two opposed open ends and defining an interior passage therethrough from pipe end to end, and b) at least one valve-controlled service connection connected to the pipe between the pipe ends, the at least one valve-controlled service connection being in fluid communication with the pipe interior passage, the at least one valve-controlled service connection being controllable between an open and a closed position, the method comprising:
i) controlling the at least one valve to the closed position;
ii) vacuuming abrasive particulate from the first pipe end through to the second pipe end in a unidirectional simultaneous full length gas stream from the first pipe end to the second pipe end;
iii) selectively controlling the at least one valve to the open position;
iv) selectively controlling the at least one valve to the closed position;
v) ceasing vacuuming from the first end to the second end; and
vi) thereafter vacuuming the abrasive particulate from the second pipe end through to the first pipe end to create a unidirectional simultaneous full length gas stream from the second pipe end to the first pipe end to remove shadow deposit encrustation areas adjacent the at least one valve-controlled service connection.

14. The method in claim 11, further comprising a step preceding i) of selectively controlling the at least one valve to the closed position.

15. The method in claim 14, further comprising a step between i) and ii) of selectively controlling the at least one valve to the open position.

16. The method in claim 15, further comprising a step of thereafter selectively controlling the at least one valve to the closed position.
